(19) United States
(12) Patent Application Publication
(10) Pub. No.: US 2020/0119412 A1
(43) Pub. Date: Apr. 16, 2020

(54) BATTERY MODULE AND BATTERY UNIT

(71) Applicant: HONDA MOTOR CO., LTD., Tokyo (JP)

(72) Inventors: Masao KAWATA, Saitama (JP); Kazuhisa IN, Saitama (JP)

(73) Assignee: HONDA MOTOR CO., LTD., Tokyo (JP)

(21) Appl. No.: 16/578,593

(22) Filed: Sep. 23, 2019

(30) Foreign Application Priority Data
Oct. 16, 2018 (JP) 2018-194993

(51) Int. Cl. H01M 10/48; H01M 2/10

(52) U.S. Cl. CPC H01M 10/482; H01M 2220/20; H01M 2/1077; H01M 10/486

(57) ABSTRACT

A battery module includes a cell stack configured by stacking a plurality of cells, a cover member configured to cover output terminals of the plurality of cells, and a detection line including a voltage detection line configured to detect a voltage of each cell or a temperature detection line configured to detect a temperature of at least one cell. The cover member includes a position regulating portion configured to arrange the detection line at predetermined positions.

### CROSS-REFERENCE TO RELATED APPLICATIONS

This application is based on and claims priority under 35 USC 119 from Japanese Patent Application No. 2018-194993 filed on Oct. 16, 2018.

### TECHNICAL FIELD

The present invention relates to a battery module and a battery unit mounted on an electric vehicle or the like.

### BACKGROUND ART

In the related art, a battery module is mounted on an electric vehicle or the like. For example, JP-A-2016-072181 discloses a battery module including a battery assembly (battery stack) configured by stacking a plurality of battery cells (cells), and a battery monitoring circuit (sensor device) that detects a voltage of each battery cell. On an upper surface of the battery assembly, a voltage detection line whose one end is connected to an electrode terminal (busbar) of the battery cell and a temperature detection line whose one end is connected to a sensor element formed by a thermistor element are provided, and the other ends of these detection lines are connected to a predetermined connection destination (such as the battery monitoring circuit) during assembling.

However, since these detection lines can be moved freely before assembling, handleability thereof is poor, which may hinder assembling work.

### SUMMARY

An aspect of the present invention provides a battery module and a battery unit capable of improving handleability of the detection line and facilitating the assembling work.

An embodiment of the present invention relates to a battery module which includes:

a cell stack configured by stacking a plurality of cells;

a cover member configured to cover output terminals of the plurality of cells; and

a detection line including a voltage detection line configured to detect a voltage of each cell, or a temperature detection line configured to detect a temperature of at least one cell,

the cover member includes a position regulating portion configured to arrange the detection line at predetermined positions.

Another embodiment of the present invention relates to a battery unit which includes:

a first battery module and a second battery module being arranged adjacent to each other,

the first battery module and the second battery module each includes:

a cell stack configured by stacking a plurality of cells;

a cover member configured to cover output terminals of the plurality of cells; and

voltage detection lines each being configured to detect a voltage of each cell,

the cover member includes a position regulating portion configured to arrange the detection lines at predetermined positions,

the first battery module further includes a sensor device arranged on an upper surface of the cell stack and configured to detect the voltage,

a first connector to which the voltage detection line of the first battery module is connected and a second connector to which the voltage detection line of the second battery module is connected are provided on a side surface of the sensor device,

the voltage detection line of the first battery module is guided by the position regulating portion of the first battery module so as to be positioned on an inner side of an outer edge portion of the cover member of the first battery module, and is connected to the first connector of the sensor device, and

at least a part of the voltage detection line of the second battery module is position-regulated by the position regulating portion of the second battery module, and is connected to the second connector of the sensor device.

According to the present invention, since the detection line can be arranged at predetermined positions by the position regulating portion of the cover member, the handleability of the detection line is improved and the assembling work can be facilitated.

### BRIEF DESCRIPTION OF DRAWINGS

FIG. 1 is a perspective view of a battery module according to an embodiment of the present invention as viewed obliquely from above.

FIG. 2 is an exploded perspective view of the battery module in FIG. 1.

FIG. 3 is a plan view of the battery module in FIG. 1.

FIG. 4 is a cross-sectional view taken along a line A-A in FIG. 3.

FIG. 5 is a perspective view showing an engagement portion between a top cover and an insulating plate of the battery module in FIG. 1.

FIG. 6 is a cross-sectional view taken along a line B-B in FIG. 5.

FIG. 7 is a plan view of a battery unit according to an embodiment of the present invention.

### DESCRIPTION OF EMBODIMENTS

Hereinafter, a battery module and a battery unit according to an embodiment of the present invention will be described with reference to the accompanying drawings. The drawings are to be viewed in a direction of the reference numerals.

[Battery Module]

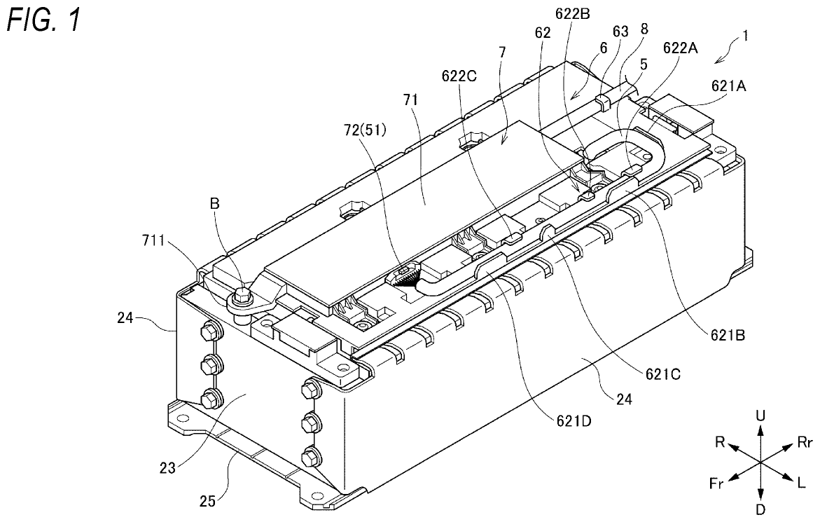

As shown in FIGS. 1 to 3, the battery module 1 according to the present embodiment includes a cell stack 2 which is configured by stacking a plurality of cells 21 in a front-rear direction and which includes a front surface, a rear surface, a left surface, a right surface, an upper surface and a lower surface; a plurality of busbars 3 which are arranged on an upper surface side of the cell stack 2 and each of which electrically connects the cells 21 with each other; a busbar plate 4 which is arranged on the upper surface side of the cell stack 2 and holds the plurality of busbars 3; a plurality of voltage detection lines 5 which are arranged on the upper surface side of the busbar plate 4 and each of which is used for detecting a voltage of each cell 21; a temperature detection line 8 which is connected to a thermistor 32 for detecting a temperature of at least one cell 21; a top cover 6 which is arranged on the upper surface side of the busbar plate 4 and covers terminals 211 of the cells 21 and the busbars 3; and a sensor device 7 which is arranged on the upper surface side of the busbar plate 4 and is used for detecting a voltage of each cell 21 via the plurality of voltage detection lines 5.

In the present specification or the like, in order to simplify and clarify the description, a stacking direction of the cells 21 is defined as the front-rear direction, and directions orthogonal to the stacking direction of the cells 21 are defined as a left-right direction and an upper-lower direction, which are independent from a front-rear direction or the like of a product on which the battery module 1 is mounted. That is, in a case where the battery module 1 is mounted on a vehicle, the stacking direction of the cells 21 may coincide with a front-rear direction of the vehicle, may be an upper-lower direction or a left-right direction of the vehicle, or may be a direction inclined from these directions. In the drawings, a front side of the battery module 1 is denoted by Fr, a rear side is denoted by Rr, a left side is denoted by L, a right side is denoted by R, an upper side is denoted by U, and a lower side is denoted by D.

(Cell Stack)

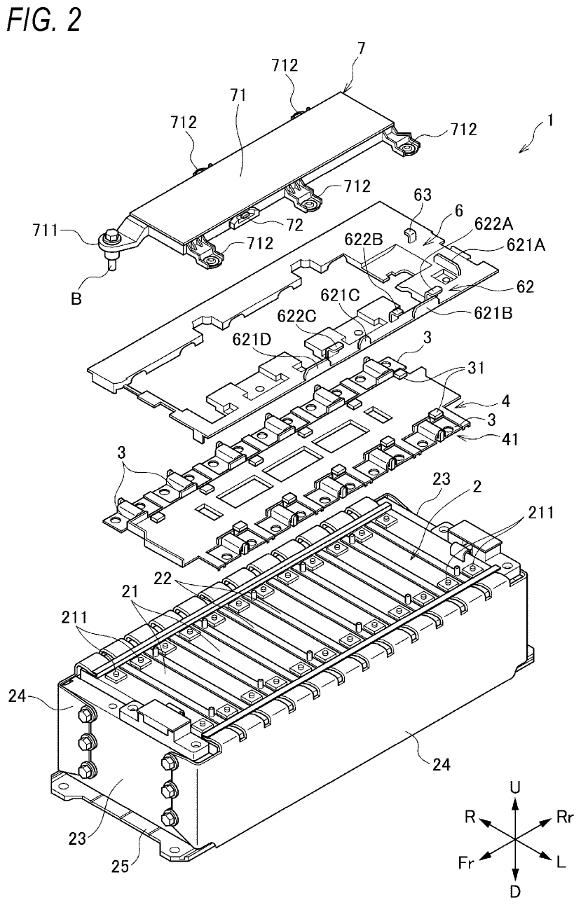

As shown in FIG. 2, the cell stack 2 is configured by alternately stacking the plurality of cells 21 and a plurality of insulating plates 22 in the front-rear direction. The cell stack 2 according to the present embodiment is held by a holding structure including a pair of end plates 23 arranged on the front surface and the rear surface of the cell stack 2, a pair of side frames 24 arranged on the left surface and the right surface of the cell stack 2 and connecting the pair of end plates 23, and a lower plate 25 arranged on the lower surface of the cell stack 2, but the holding structure of the cell stack 2 is not limited thereto.

(Busbar)

The plurality of busbars 3 each connect terminals 211 of adjacent cells 21 such that the plurality of cells 21 are electrically connected in series. Specifically, the plurality of cells 21 are stacked such that positive terminals 211 and negative terminals 211 are sequentially reversed left and right, and the plurality of busbars 3 each sequentially connect a positive (or negative) terminal 211 of an adjacent cell 21 on an upstream side of the cell stacking direction and a negative (or positive) terminal 211 of an adjacent cell 21 on a downstream side of the cell stacking direction, so that the plurality of cells 21 are electrically connected in series.

(Busbar Plate)

The busbar plate 4 includes a plurality of busbar holding portions 41, and when the busbar plate 4 is placed on the upper surface of the cell stack 2 after each holds a plurality of busbars 3, the plurality of busbars 3 are positioned at predetermined positions where the busbar 3 can connect corresponding terminals 211. The busbar plate 4 according to the present embodiment is not a jig that is removed after the busbars 3 are connected to the terminals 211, but is a component of the battery module 1 that is maintained at an attached state after the busbars 3 are connected to the terminals 211.

(Voltage Detection Line)

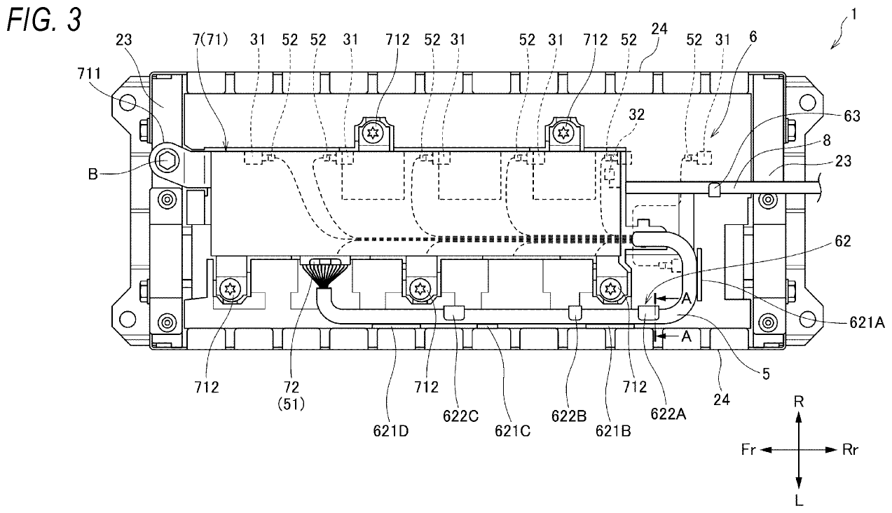

One end of each of the plurality of voltage detection lines 5 is connected to each busbar 3, and the other end is connected to the sensor device 7 via a cable-side connector 51. As shown in FIG. 3, a terminal portion 52 is provided at one end of each voltage detection line 5, and the terminal portion 52 is connected to a terminal portion 31 provided on each busbar 3 by welding or the like. One end side of the plurality of voltage detection lines 5 is routed along the upper surface of the busbar plate 4, and the other end side is pulled out to the upper surface side of the top cover 6 in a state of being bound. The voltage detection lines 5 are connected to the sensor device 7 via the cable-side connector 51, so that the voltage of each cell 21 can be detected, but the other end side of the voltage detection lines 5 is in a freely movable state before the assembling process in which the connection to the sensor device 7 is performed, so that the handleability is poor, which may hinder the assembling work.

(Top Cover)

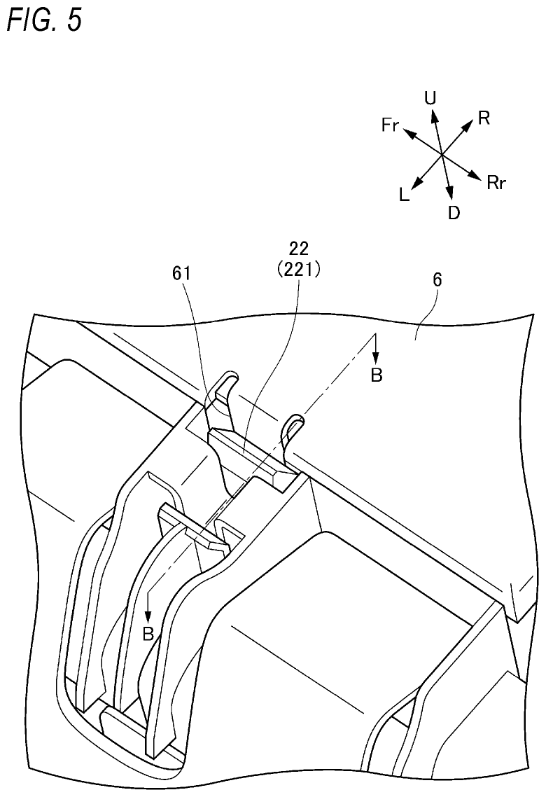

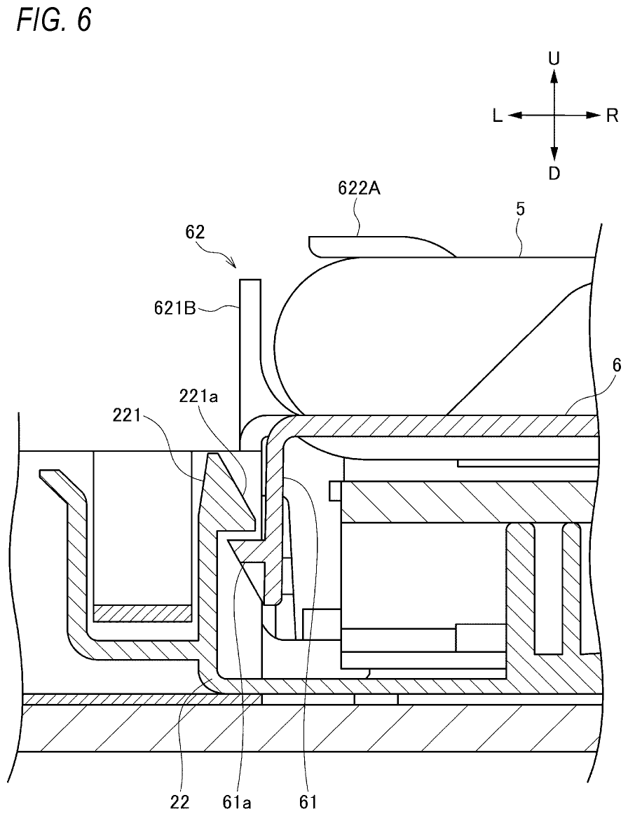

The top cover 6 is a cover member made of resin, and is attached to the upper surface side of the busbar plate 4 so as to cover at least the terminals 211 of the cells 21 and the plurality of busbars 3. The top cover 6 according to the present embodiment is attached using the plurality of insulating plates 22 each provided between adjacent cells 21. Specifically, with reference to FIGS. 5 and 6, all insulating plates 22 or specific insulating plates 22 are each provided with an engagement portion 221 extending upward from left and right ends of an upper end, and the top cover 6 is provided with an engagement portions 61 extending downward from both left and right ends. During assembling of the top cover 6, when the top cover 6 is mounted at a predetermined mounting position from above, a claw portion 221a formed on the engagement portion 221 of the insulating plate 22 and a claw portion 61a formed on the engagement portion 61 of the top cover 6 are engaged with each other, and the top cover 6 is fixed to the cell stack 2. According to such a mounting structure of the top cover 6, since a fixing member for fixing the top cover 6 is unnecessary, the number of parts can be reduced.

As shown in FIGS. 1 to 3, the top cover 6 includes a position regulating portion 62 for arranging the other end side of the voltage detection lines 5 at a predetermined position, and a position regulating portion 63 for arranging the temperature detection line 8 at a predetermined position. According to such a top cover 6, since the voltage detection lines 5 and the temperature detection line 8 can be arranged at predetermined positions by the position regulating portions 62, 63 of the top cover 6, the handleability of the voltage detection lines 5 and the temperature detection line 8 is improved, and the assembling work can be facilitated. The position regulating portions 62, 63 according to the present embodiment are formed integrally with the top cover 6 made of resin. Therefore, the attachment work of attaching the position regulating portions 62, 63 to the top cover 6 is eliminated. Hereinafter, the position regulating portion 62 will be described in detail.

As shown in FIGS. 1 and 3, the position regulating portion 62 guides the voltage detection lines 5 such that the voltage detection lines 5 are positioned at an inner side of an outer edge portion of the top cover 6. For example, the other end side of the voltage detection lines 5 according to the present embodiment is pulled out to the upper surface side of the top cover 6 so as to face rearward, but the position regulating portion 62 guides the other end side of the voltage detection lines 5 pulled out rearward toward the left side, and then guides the voltage detection lines 5 toward the front side, and to follow an inner side of a left outer edge portion of the top cover 6. According to such a position regulating portion 62, the voltage detection lines 5 can be positioned on the inner side of the outer edge portion of the top cover 6, so that it is possible to prevent the assembly workability from being lowered due to protrusion of the voltage detection lines 5.

The position regulating portion 62 includes a plurality of guide portions 621A to 621D which are erected on the upper surface of the top cover 6 and are used for regulating the movement of the voltage detection lines 5, and a plurality of fixing portions 622A to 622C for fixing the voltage detection lines 5 to the upper surface of the top cover 6.

The first guide portion 621A is erected on the upper surface of the top cover 6 along the left-right direction, and regulates a backward movement while guiding the other end side of the voltage detection lines 5 along the left-right direction. The second guide portion 621B to the fourth guide portion 621D are erected on the upper surface (left side outer edge portion) of the top cover 6 along the front-rear direction, and regulate a leftward and outward movement while guiding the other end side of the voltage detection lines 5 along the front-rear direction. According to such guide portions 621A to 621D, the voltage detection lines 5 can be guided with a simple configuration by regulating the movement of the voltage detection lines 5 in at least one direction.

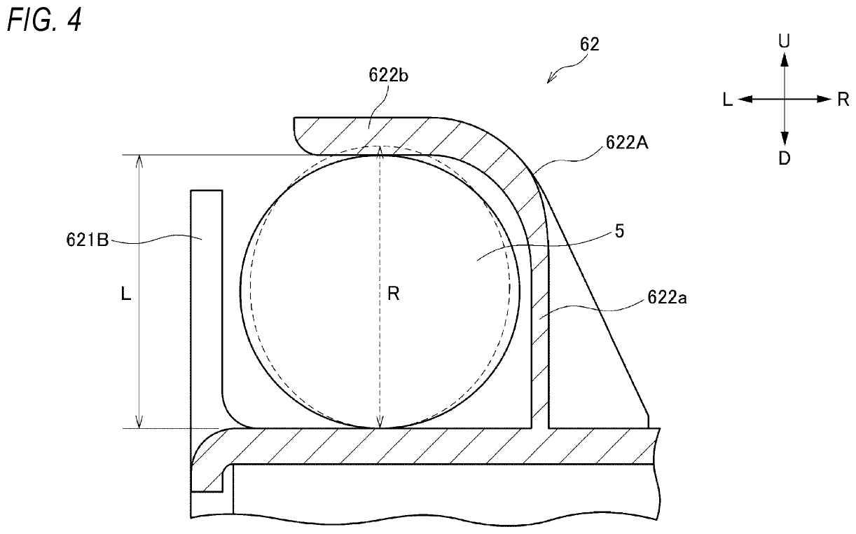

As shown in FIG. 4, the first to third fixing portions 622A to 622C each include a vertical wall portion 622a erected on the upper surface of the top cover 6, and a ceiling wall portion 622b extending substantially parallel to the upper surface of the top cover 6 from an upper end of the vertical wall portion 622a. According to such fixing portions 622A to 622C, the vertical wall portions 622a regulate the movement of the other end side of the voltage detection lines 5 in at least one direction, and the upper surface of the top cover 6 and the ceiling wall portions 622b regulate the upper-lower direction movement of the other end side of the voltage detection lines 5, so that the other end side of the voltage detection lines 5 can be fixed to the upper surface of the top cover 6.

The first to third fixing portions 622A to 622C are formed such that a distance L between the upper surface of the top cover 6 and the ceiling wall portion 622b is smaller than a wire diameter R on the other end side of the voltage detection lines 5. According to such fixing portions 622A to 622C, since the other end side of the voltage detection lines 5 can be sandwiched in the upper-lower direction between the upper surface of the top cover 6 and the ceiling wall portions 622b, the movement of the voltage detection lines 5 can be reliably regulated.

As shown in FIG. 3, the second to fourth guide portions 621B to 621D and the vertical wall portions 622a of the first to third fixing portions 622A to 622C which constitute the position regulating portion 62 are arranged so as to sandwich the voltage detection lines 5 in a plan view. According to such a position regulating portion 62, not only the upper-lower direction movement of the other end side of the voltage detection lines 5 can be regulated by the upper surface of the top cover 6 and the ceiling wall portions 622b of the fixing portions 622A to 622C, but also the horizontal movement of the other end side of the voltage detection lines 5 can be regulated by the guide portions 621B to 621D and the vertical wall portions 622a of the fixing portions 622A to 622C which are arranged so as to sandwich the other end side of the voltage detection lines 5.

Further, as shown in FIG. 3, the second to fourth guide portions 621B to 621D and the first to third fixing portions 622A to 622C which constitute the position regulating portion 62 are alternately provided along an extending direction of the other end side of the voltage detection lines 5. According to such a position regulating portion 62, the movement of the other end side of the voltage detection lines 5 is reliably regulated by the guide portions 621B to 621D and the fixing portions 622A to 622C, and the guide portions 621B to 621D can be prevented from being obstacles when the other end side of the voltage detection lines 5 is fixed to the fixing portions 622A to 622C, so that the routing work of the other end side of the voltage detection lines 5 is facilitated. Since the position regulating portion 63 for arranging the temperature detection line 8 at a predetermined position has the same configuration as the first to third fixing portions 622A to 622C, detailed description thereof is omitted.

(Sensor Device)

As shown in FIGS. 1 to 3, the sensor device 7 includes a case 71 in which a voltage detection substrate (not shown) is accommodated and a voltage detection connector 72 which is arranged on a side surface of the case 71 and is connected to the busbars 3 via the cable-side connector 51 and the voltage detection lines 5. Although the sensor device 7 according to the present embodiment includes one voltage detection connector 72 for detecting a voltage of one battery module 1, two or more voltage detection connectors 72 can be provided in a case of performing voltage detection of two or more battery modules 1.

The case 71 includes a fixing portion 711 that is fixed to the end plate 23 via a bolt B, and a plurality of locking portions 712 that are locked on the top cover 6, and the sensor device 7 is assembled to the battery module 1 via the fixing portion 711 and the plurality of locking portions 712.

As shown in FIGS. 1 and 3, the cable-side connector 51 provided at the other ends of the voltage detection lines 5 is connected to the voltage detection connector 72 of the sensor device 7 in a predetermined process. At this time, if the other end side of the voltage detection lines 5 is in a state of being position-regulated by the position regulating portion 62 of the top cover 6, not only the cable-side connector 51 can be easily connected to the voltage detection connector 72 of the sensor device 7, but also the other end side of the voltage detection lines 5 can be position-regulated by the position regulating portion 62 of the top cover 6 even when the battery module 1 is being used.

[Battery Module]

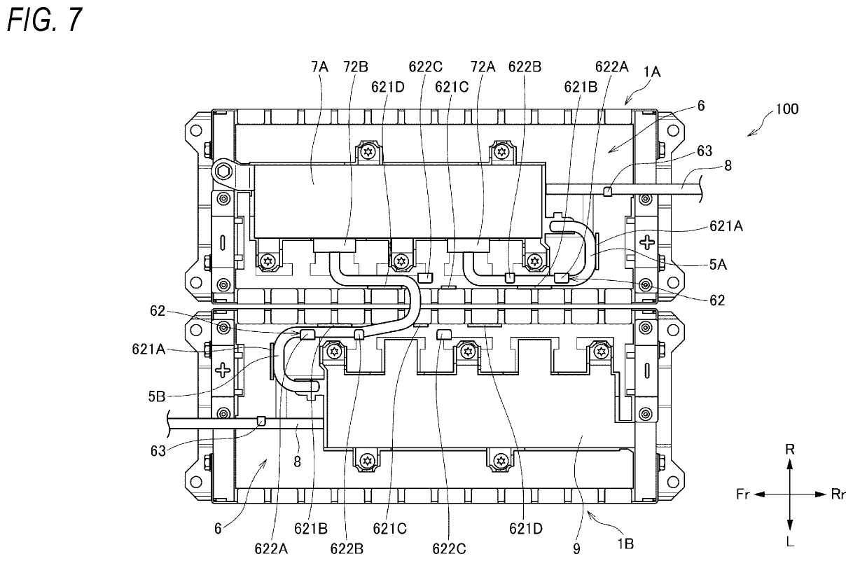

Next, a battery unit 100 including a first battery module 1A and a second battery module 1B arranged adjacent to each other will be described with reference to FIG. 7. For the configuration common to the battery module 1 described above, the description of the battery module 1 is cited by using the same reference numerals as those of the battery module 1.

Similar to the battery module 1, the first battery module 1A and the second battery module 1B each includes the cell stack 2 configured by stacking a plurality of cells 21; the top cover 6 which covers the terminals 211 of the plurality of cells 21; voltage detection lines 5A, 5B configured to detect a voltage of each cell 21; and the temperature detection line 8 which is connected to the thermistor 32 and detects a temperature of the cell stack 2. The top cover 6 includes the position regulating portion 62 for arranging the voltage detection lines 5A, 5B at predetermined positions, and the position regulating portion 63 for arranging the temperature detection line 8 at a predetermined position.

The first battery module 1A includes a sensor device 7A which is arranged on the upper surface side of the cell stack 2 and is used for detecting a voltage of each cell 21. A first voltage detection connector 72A to which the voltage detection lines 5A of the first battery module 1A are connected and a second voltage detection connector 72B to which the voltage detection lines 5B of the second battery module 1B are connected are provided on the side surface of the sensor device 7A arranged in the first battery module 1A. According to such a battery unit 100, since the voltage detection lines 5B of the second battery module 1B are connected to the sensor device 7A arranged in the first battery module 1A, a sensor device is unnecessary for the second battery module 1B. In FIG. 7, a dummy cover is denoted by a reference numeral 9.

The other end side of the voltage detection lines 5A of the first battery module 1A is guided by the position regulating portion 62 provided on the top cover 6 of the first battery module 1A so as to be positioned on an inner side of the outer edge portion of the top cover 6 of the first battery module 1A, and is connected to the first voltage detection connector 72A of the sensor device 7A. Since the voltage detection lines 5A of the first battery module 1A are shorter than the voltage detection lines 5 of the battery module 1, the other end side of the voltage detection lines 5A is guided by the first and second guide portions 621A, 621B and the first and second fixing portions 622A, 622B which are a part of the position regulating portion 62.

The other end side of the voltage detection lines 5B of the second battery module 1B is at least partially position-regulated by the position regulating portion 62 provided on the top cover 6 of the second battery module 1B, and is connected to the second voltage detection connector 72B of the sensor device 7A arranged in the first battery module 1A. Specifically, the other end side of the voltage detection lines 5B of the second battery module 1B is connected to the second voltage detection connector 72B of the sensor device 7A in a state of being position-regulated by the first and second guide portions 621A, 621B and the first and second fixing portions 622A, 622B which are a part of the position regulating portion 62.

According to such a battery unit 100, the other end side of the voltage detection lines 5B of the second battery module 1B can also be position-regulated by a part of the position regulating portion 62 provided on the top cover 6 of the second battery module 1B in a case where the voltage detection lines 5B of the second battery module 1B is connected to the sensor device 7A arranged in the first battery module 1A. In the battery unit 100 according to the present embodiment, the first battery module 1A and the second battery module 1B share the top cover 6, so that the cost can be reduced.

The above embodiment may be appropriately modified, improved, or the like. For example, in the above embodiment, although the voltage detection line 5 and the temperature detection line 8 are disposed on the upper surface of the top cover 6, at least one of the voltage detection line 5 and the temperature detection line 8 may be disposed on the upper surface of the top cover 6.

At least the following matters are described in the present specification. Corresponding components in the above-described embodiments are shown in parentheses, without being limited thereto.

(1) A battery module (battery module 1), includes:

a cell stack (cell stack 2) configured by stacking a plurality of cells (cells 21);

a cover member (top cover 6) configured to cover output terminals (terminals 211) of the plurality of cells; and

a detection line including a voltage detection line (voltage detection lines 5) configured to detect a voltage of each cell, or a temperature detection line (temperature detection line 8) configured to detect a temperature of at least one cell, and

the cover member includes a position regulating portion (position regulating portion 62) configured to arrange the detection lines at predetermined positions.

According to (1), since the detection lines can be arranged at predetermined positions by the position regulating portion of the cover member, the handleability of the detection lines is improved and the assembling work can be facilitated.

(2) In the battery module described in (1),

the position regulating portion is configured to guide the detection line such that the detection line is positioned at an inner side of an outer edge portion of the cover member.

According to (2), the voltage detection line can be positioned on the inner side of the outer edge portion of the cover member by the position regulating portion, so that protrusion of the voltage detection lines can be prevented.

(3) In the battery module described in (1) or (2),

the cover member is made of resin, and

the position regulating portion is formed integrally with the cover member.

According to (3), the position regulating portion is integrally formed with the cover member by resin, and thus the work of attaching the position regulating portion to the cover member can be eliminated.

(4) In the battery module described in any one of (1) to (3),

the position regulating portion includes a guide portion (guide portions 621A to 621D) erected on an upper surface of the cover member and configured to regulate a movement of the detection lines.

According to (4), the detection line can be guided with a simple configuration by the guide portions that regulate the movement of the detection lines in at least one direction.

(5) In the battery module described in any one of (1) to (4),

the position regulating portion includes a fixing portion (fixing portions 622A to 622C) configured to fix the detection line on the upper surface of the cover member.

According to (5), the movement of the detection line can be reliably regulated by the fixing portion configured to fix the detection line on the upper surface of the cover member.

(6) In the battery module described in (5),

the fixing portion includes a vertical wall portion (vertical wall portion 622a) erected on the upper surface of the cover member, and a ceiling wall portion (ceiling wall portion 622b) extending substantially parallel to the upper surface from the vertical wall portion, and

a distance (distance L) between the upper surface and the ceiling wall portion is smaller than a wire diameter (wire diameter R) of the detection line.

According to (6), since the distance between the upper surface of the cover member and the ceiling wall portion of the fixing portion is smaller than the wire diameter of the detection line, the detection line can be sandwiched in the upper-lower direction by the fixing portion, and the movement of the detection line can be regulated.

(7) In the battery module described in any one of (1) to (6),

the battery module further includes:

a sensor device (sensor device 7) arranged on an upper surface of the cell stack and configured to detect the voltage,

the detection line is voltage detection line, and

the voltage detection lines are connected to a connector (voltage detection connector 72) provided on a side surface of the sensor device.

According to (7), since the detection line is a voltage detection line and is connected to a connector provided on the side surface of the sensor device, the voltage detection line can be easily connected to the sensor device in a state of being position-regulated by the position regulating portion on the upper surface of the cell stack.

(8) In the battery module described in any one of (1) to (7),

the battery module further includes:

insulating plates (insulating plates 22) each being provided between adjacent cells, and

the cover member is provided with an engagement portion (engagement portion 221) engaged with the insulating plate.

According to (8), since the cover member is provided with an engagement portion engaged with the insulating plate, it is unnecessary to provide a fixing member for fixing the cover member, and the number of parts can be reduced.

(9) In the battery module described in any one of (1) to (8),

the position regulating portion includes:

the guide portion (guide portions 621A to 621D) erected on the upper surface of the cover member and configured to regulate the movement of the detection line, and

the fixing portion (fixing portions 622A to 622C) configured to fix the detection lines on the upper surface of the cover member,

the fixing portion includes the vertical wall portion (vertical wall portion 622a) erected on the upper surface of the cover member, and the ceiling wall portion (ceiling wall portion 622b) extending substantially parallel to the upper surface from the vertical wall portion, and

the guide portion and the vertical wall portion of the fixing portion are arranged so as to sandwich the detection line in a plan view.

According to (9), an upper-lower direction movement of the detection line can be regulated by the ceiling wall portion of the fixing portion, and further, a horizontal movement of the detection line can also be regulated by the guide portion and the vertical wall portion of the fixing portion which are arranged to sandwich the detection line.

(10) In the battery module described in (9),

a plurality of the guide portions and the fixing portions are provided, and

at least a part of the guide portions and the fixing portions are alternately provided along an extending direction of the detection lines.

According to (10), since at least a part of the guide portions and the fixing portions are alternately provided along the extending direction of the detection lines, the movement of the detection lines can be regulated and the detection line can be easily routed.

(11) A battery unit (battery unit 100) includes a first battery module (first battery module 1A) and a second battery module (second battery module 1B) which are arranged adjacently,

the first battery module and the second battery module each includes:

a cell stack (cell stack 2) configured by stacking a plurality of cells (cells 21);

a cover member (top cover 6) configured to cover output terminals (terminals 211) of the plurality of cells; and

voltage detection lines (voltage detection lines 5A, 5B) each being configured to detect a voltage of each cell,

the cover member includes a position regulating portion (position regulating portion 62) configured to arrange the detection lines at predetermined positions,

the first battery module further includes a sensor device (sensor device 7) arranged on an upper surface of the cell stack and configured to detect the voltage,

a first connector (first voltage detection connector 72A) to which the voltage detection line of the first battery module is connected and a second connector (second voltage detection connector 72B) to which the voltage detection line of the second battery module is connected are provided on a side surface of the sensor device,

the voltage detection line of the first battery module is guided by the position regulating portion of the first battery module so as to be positioned on an inner side of an outer edge portion of the cover member of the first battery module, and is connected to the first connector of the sensor device, and

at least a part of the voltage detection line of the second battery module is regulated by the position regulating portion of the second battery module, and is connected to the second connector of the sensor device.

According to (11), the voltage detection line of the first battery module can be positioned on the inner side of the outer edge portion of the cover member by the position regulating portion of the first battery module, so that protrusion of the voltage detection line can be prevented. Since the detection line of the first battery module is connected to the connector provided on the side surface of the sensor device, the voltage detection line can be easily connected to the sensor device in a state of being position-regulated by the position regulating portion on the upper surface of the cell stack. Further, since the voltage detection line of the second battery module is connected to the sensor device arranged in the first battery module, a sensor device is unnecessary for the second battery module.

(12) In the battery unit described in (11),

the cover member of the first battery module and the cover member of the second battery module each includes a plurality of position regulating portions, and

the voltage detection line of the second battery module is position-regulated by only a part of the plurality of position regulating portions.

According to (12), the cover member can be shared by the first battery module and the second battery module.

1. A battery module, comprising:
a cell stack configured by stacking a plurality of cells;
a cover member configured to cover output terminals of the plurality of cells; and
a detection line including a voltage detection line configured to detect a voltage of each cell, or a temperature detection line configured to detect a temperature of at least one cell,
wherein the cover member includes a position regulating portion configured to arrange the detection line at predetermined positions.

2. The battery module according to claim 1,
wherein the position regulating portion is configured to guide the detection lines such that the detection lines are positioned at an inner side of an outer edge portion of the cover member.

3. The battery module according to claim 1,
wherein the cover member is made of resin, and
wherein the position regulating portion is formed integrally with the cover member.

4. The battery module according to claim 1,
wherein the position regulating portion includes a guide portion erected on an upper surface of the cover member and configured to regulate a movement of the detection lines.

5. The battery module according to claim 1,
wherein the position regulating portion includes a fixing portion configured to fix the detection line on the upper surface of the cover member.

6. The battery module according to claim 5,
wherein the fixing portion includes a vertical wall portion erected on the upper surface of the cover member, and a ceiling wall portion extending substantially parallel to the upper surface from the vertical wall portion, and
wherein a distance between the upper surface and the ceiling wall portion is smaller than a wire diameter of the detection line.

7. The battery module according to claim 1, further comprising:
a sensor device arranged on an upper surface of the cell stack and configured to detect the voltage,
wherein the detection line is the voltage detection line, and
wherein the voltage detection line are connected to a connector provided on a side surface of the sensor device.

8. The battery module according to claim 1, further comprising:
an insulating plate provided between adjacent cells,
wherein the cover member is provided with an engagement portion to be engaged with the insulating plate.

9. The battery module according to claim 1,
wherein the position regulating portion includes:
the guide portion erected on the upper surface of the cover member and configured to regulate the movement of the detection line, and
the fixing portion configured to fix the detection line to the upper surface of the cover member,
wherein the fixing portion includes the vertical wall portion erected on the upper surface of the cover member, and the ceiling wall portion extending substantially parallel to the upper surface from the vertical wall portion, and
wherein the guide portion and the vertical wall portion of the fixing portion are arranged so as to sandwich the detection lines in a plan view.

10. The battery module according to claim 9,
wherein a plurality of the guide portions and the fixing portions are provided, and
wherein at least a part of the guide portions and the fixing portions are alternately provided along an extending direction of the detection lines.

11. A battery unit, comprising:
a first battery module and a second battery module which are arranged adjacently,
wherein the first battery module and the second battery module each includes:
a cell stack configured by stacking a plurality of cells;
a cover member configured to cover output terminals of the plurality of cells; and
voltage detection lines each being configured to detect a voltage of each cell,
wherein the cover member includes a position regulating portion configured to arrange the detection lines at predetermined positions,
wherein the first battery module further includes a sensor device arranged on an upper surface of the cell stack and configured to detect the voltage,
wherein a first connector to which the voltage detection line of the first battery module is connected and a second connector to which the voltage detection line of the second battery module is connected are provided on a side surface of the sensor device,
wherein the voltage detection line of the first battery module is guided by the position regulating portion of the first battery module so as to be positioned on an inner side of an outer edge portion of the cover member of the first battery module, and is connected to the first connector of the sensor device, and
wherein at least a part of the voltage detection line of the second battery module is position-regulated by the position regulating portion of the second battery module, and is connected to the second connector of the sensor device.

12. The battery unit according to claim 11,
wherein the cover member of the first battery module and the cover member of the second battery module each includes a plurality of position regulating portions, and
wherein the voltage detection line of the second battery module is position-regulated by only a part of the plurality of position regulating portions.
